(19) United States
(12) Patent Application Publication
(10) Pub. No.: US 2024/0380244 A1
(43) Pub. Date: Nov. 14, 2024

(54) HOUSEHOLD APPLIANCE

(71) Applicant: Diehl AKO Stiftung & Co. KG, Wangen (DE)

(72) Inventors: Zhongke Li, Nanjing (CN); Zhang Wei, Nanjing (CN); Da Li, Nanjing (CN); Fengqun Cui, Nanjing (CN)

(21) Appl. No.: 18/633,579

(22) Filed: Apr. 12, 2024

(30) Foreign Application Priority Data
May 10, 2023 (CN) 202321121900.2

(51) Int. Cl. H02J 50/10; H02J 50/00; H02J 50/70

(52) U.S. Cl. CPC H02J 50/10; H02J 50/005; H02J 50/70

(57) ABSTRACT

A household appliance contains a metal panel and a detachable control device. A button is embedded in the metal panel, the button has a non-conductive operation surface, and a primary induction coil is provided on the rear side thereof. A secondary induction coil is provided in the control device and is provided with a first magnetic conductor, which contains a first central column, a first flat plate carrying the primary induction coil and a first sidewall encircling the periphery of the primary induction coil. The secondary induction coil is provided with a second magnetic conductor, which contains a second central column located in the center of the secondary induction coil and a second flat plate carrying the secondary induction coil. A conducted magnetic flux tightly surrounds the primary and secondary induction coils, so as to avoid occurrence of eddy current heating in the metal panel and improve the charging efficiency.

### CROSS-REFERENCE TO RELATED APPLICATION

This application claims the priority, under 35 U.S.C. § 119, of Chinese Patent Application CN 202321121900.2, filed May 10, 2023; the prior application is herewith incorporated by reference in its entirety.

### FIELD AND BACKGROUND OF THE INVENTION

The present invention relates to a household appliance, in particular to wireless charging technology in a household appliance.

In order to meet modern household fashion, an industrial appearance design with ultimate simplicity and full metal texture is sought in the field of household appliances. For this purpose, the household appliances can be manipulated using a control device that is separate from or detachable from the appliance body. Reference may be made in this regard to Chinese utility model patent CN 217935588 U of the present applicant.

In order to avoid battery replacement or wired charging of such a detachable control device, it is particularly advantageous to implement a wireless charging of the detachable control device with the aid of buttons embedded in a panel and having an operation surface made of a non-conductive material, while maintaining as much as possible a metallic appearance. However, in practice it has been found that: in existing wireless charging solutions, magnetic lines or magnetic flux, used to charge the detachable control device, partially passes the metal panel around the button. On the one hand, this causes eddy currents to be induced in the surrounding metal panel, which in turn causes the metal panel to heat up. On the other hand, this can result in significant eddy current losses, making charging of the detachable control device inefficient. Moreover, these disadvantageous effects are exacerbated by the limited size of the button and its operation surface.

A problem to be solved is how to improve the wireless charging of such a detachable control device in household appliances to avoid occurrence of eddy current heating in the metal panel and to improve charging efficiency.

### SUMMARY OF THE INVENTION

The object of the invention is to provide a household appliance which overcomes the above-mentioned disadvantages of wireless charging of a detachable control device in a simple, effective and low-cost manner.

In order to achieve the aforesaid object, the household appliance according to the present invention contains: an appliance body having a metal panel, and a detachable control device. Wherein a button is embedded in the metal panel and the button has an operation surface made of an non-conductive material. A primary induction coil is provided on the rear side of the operation surface, and a secondary induction coil is correspondingly provided in the detachable control device, so that the detachable control device can be charged by means of the magnetic flux conducted between the primary induction coil and the secondary induction coil when the detachable control device overlies the button.

In the invention, the primary induction coil is provided with a first magnetic conductor, which contains a first central column located in the center of the primary induction coil, a first flat plate carrying the primary induction coil and a first sidewall at least partially encircling the periphery of the primary induction coil. The secondary induction coil is provided with a second magnetic conductor, which at least contains a second central column located in the center of the secondary induction coil and a second flat plate carrying the secondary induction coil, by means of the first magnetic conductor and the second magnetic conductor, the conducted magnetic flux tightly surrounds the primary induction coil and the secondary induction coil.

The appliance body according to the invention can be configured as a body part for performing functions of a household appliance, for example, in the field of kitchen appliances, for performing functions such as refrigeration, freezing, steaming and roasting, dishwashing, cooking, etc., or in the field of cleaning appliances, for performing functions such as washing, drying, etc. Accordingly, the appliance body can in particular be wirelessly manipulated by a detachable control device, for example wirelessly communicating with the appliance body by means of the detachable control device.

In order to achieve the wireless charging for the detachable control device on the appliance body, a button is embedded in a panel of the appliance body, and the button has an operation surface made of a non-conductive material, wherein a primary induction coil is integrated on the rear side of said operation surface, and a secondary induction coil is correspondingly integrated in the detachable control device. Thus, with the detachable control device overlying the button, the primary induction coil located in the appliance body or the button can inductively couple with the secondary induction coil in the detachable control device and conduct magnetic flux, thereby performing wireless energy transfer and further charging the detachable control device. In particular, when an alternating excitation current passes through the primary induction coil, the secondary induction coil in the detachable control device can be excited through the inductive coupling between the secondary induction coil and the primary induction coil to induce an alternating induction current, which is rectified to charge the battery of the detachable control device.

According to the invention, the primary and secondary induction coil are respectively provided with a first magnetic conductor and a second magnetic conductor. The first magnetic conductor may be divided into three parts: a first central column located in the center of the primary induction coil, a first flat plate carrying the primary induction coil and a first sidewall at least partially encircling the periphery of the primary induction coil. With such a structure of the first magnet conductor, the primary induction coil located in the button can be received in the annular groove formed by the first central column, the first flat plate and the first sidewall. In the detachable control device, the secondary magnetic conductor at least comprises a second central column located in the center of the secondary induction coil and a second flat plate carrying the secondary induction coil. The first magnetic conductor and the second magnetic conductor can control the density and the direction of magnetic flux to significantly concentrate the magnetic field distribution, so that the magnetic flux conducted between the primary induction coil and the secondary induction coil tightly surrounds the primary induction coil and the secondary induction coil and escapes to the metal panel as little as possible, thereby reducing the magnetic flux leakage on the metal panel area, thereby suppressing the heating of the metal panel due to the induced eddy currents, obviously reducing the eddy current loss, and significantly increasing the efficiency of the wireless charging.

It is specifically noted that in the invention, the primary and secondary induction coils may have any common shape, such as circular, square, oval, etc. Correspondingly, the first central column, the second central column, the first flat plate, the second flat plate, the first sidewall and the second sidewall which will be mentioned below are also to be designed in a manner adapted to the primary and secondary induction coils. However, in consideration of factors such as button shape, winding cost, mechanical strength, and the like, it is preferable to use a circular coil.

It is also to be noted that the first central column, the second central column, the first flat plate, the second flat plate, the first sidewall and the second sidewall which will be mentioned below are to be more understood as the division of the regions based on their respective structural features. In order to avoid possible air gaps between respective sections, the respective portions of the first and second magnetic conductor are preferably integrally formed.

According to an embodiment of the invention, the projection of the first sidewall on the operation surface is in the shape of a circular ring, a semi-circular ring, or two or more annular sectors spaced apart from each other. Here, the first sidewall may have a variety of configurations. Particularly preferred is a first sidewall having a projection in the shape of a circular ring, i.e. the first sidewall completely encircles the periphery of the primary induction coil. This makes it possible to minimize magnetic leakage to the metal panel and to shield the interior of the appliance body from magnetic fields. However, in order to be able to leave a structural space for other components (such as light-guiding components, electrical elements, etc.) and/or to facilitate the extraction of the coil leads, a first sidewall having a projection in the semi-circular shape or in the shape of two or more sectors spaced apart from each other also can be used.

According to an embodiment of the invention, the projection area of the first sidewall on the operation surface substantially corresponds to the projection area of the first central column on the operation surface, so that the magnetic flux density can be uniformly distributed in the center and on the periphery of the primary induction coil.

According to a preferable embodiment of the invention, the second magnetic conductor further contains a second sidewall which at least partially encircles the periphery of the secondary induction coil. By arranging a second sidewall, in particular a second sidewall corresponding to the projection of the first sidewall, it is possible to confine the magnetic flux in the magnetic path determined by the first magnetic conductor and the second magnetic conductor, thereby optimizing the orientation and distribution of the wireless charging magnetic field again, further reducing eddy current loss and improving the wireless charging efficiency.

According to an embodiment of the invention, the projection of the second sidewall on the operation surface is in the shape of a circular ring, a semi-circular ring, or two or more annular sectors spaced apart from each other. Similarly to the first sidewall, the second sidewall having a projection in the circular shape is more preferable here. This makes it possible to minimize magnetic leakage to the metal panel and to shield other electrical elements inside the detachable controllable device from magnetic fields. However, in order to be able to leave a structural space for other components (such as light-guiding components, electrical elements, etc.) and/or to facilitate the extraction of the coil leads, it is also possible to use a second sidewall having a projection in the semi-circular shape or in the shape of two or more sectors spaced apart from each other.

According to an embodiment of the invention, the projection area of the second sidewall on the operation surface substantially corresponds to the projection area of the secondary central column on the operation surface, so that the magnetic flux density can be uniformly distributed in the center and on the periphery of the secondary induction coil.

According to an embodiment of the invention, the first magnetic conductor and the second magnetic conductor are made of a material having a high magnetic permeability. The material having a high magnetic permeability refers to ferromagnetic materials with a magnetic permeability of about 100 or more, also known as soft magnetic material. Such a material requires high magnetic permeability, high saturation induction, high electrical resistance, low loss, good stability, and the like.

According to an embodiment of the invention, the first magnetic conductor and/or the second magnetic conductor are made of ferrite. Here, ferrite may be, for example, manganese zinc ferrite, nickel zinc ferrite, magnesium manganese zinc ferrite, cobalt nickel zinc ferrite, or the like.

According to an embodiment of the invention, the thickness of the first magnetic conductor is greater than the thickness of the second magnetic conductor in a vertical direction perpendicular to the operation surface. In the context of the present invention, the button located inside the appliance body may have a larger longitudinal space with respect to the detachable control device. It is advantageously possible to design the first and second magnetic conductors to be asymmetrical in thickness.

According to an embodiment of the invention, the thickness of the first magnetic conductor is between 7 and 15 mm; and/or the thickness of the second magnetic conductor is between 2.5 and 5 mm; and/or the diameters of the first magnetic conductor and the second magnetic conductor lie between 15 and 28 mm.

According to an embodiment of the invention, the primary induction coil and the secondary induction coil are respectively formed as one or more layers of induction coils wound on a plane parallel to the operation surface. It is particularly advantageous to increase the inductance, quality factor and resistance by using a coiled multi-layer of induction coil, e.g. double or triple layer of induction coil, thereby optimizing the charging effect.

According to an embodiment of the present invention, the projection of the secondary induction coil on the operation surface overlaps or exceeds the projection of the primary induction coil on the operation surface. In order to avoid the impact on wireless charging caused by dislocation that may occur when the detachable control device is overlaying the button, it is particularly possible to consider designing the size of the secondary induction coil to be slightly larger than the primary induction coil.

According to an embodiment of the invention, the projection area of the second sidewall on the operation surface is equal to or greater than the projection area of the first sidewall on the operation surface. In contrast to the usual charging scenarios, the means to be charged here, that is, the detachable control device, can have a more flexible spatial design than the device to be supplied with power, i.e. the buttons of limited size. To this end, it is possible to advantageously enlarge the second sidewall, thereby actively directing the magnetic flux between the primary induction coil and the secondary induction coil.

According to an embodiment of the invention, in the detachable control device, at least one magnet for attaching the detachable control device to the metal panel is provided on the outer side of the secondary induction coil and the second magnetic conductor. This embodiment can in particular be used in conjunction with an embodiment with a second sidewall so that the wireless charging magnetic field is not disturbed by the magnet.

According to an embodiment of the invention, the operation surface of the button protrudes from the metal panel in the case of charging the detachable control device. In this case, it is advantageous to avoid magnetic leakage to the metal panel area by making the buttons slightly higher than the panel.

According to an embodiment of the invention, the appliance body is a refrigerator, a dishwasher, an electric oven, an electric steamer, a microwave oven, an electric rice cooker, a coffee maker, a stove, a washing machine, a clothes dryer, an electric water heater or a stereo, or the like.

Other features of the invention are derived from the accompanying drawings and from the detailed description of the present invention. All the features and feature combinations mentioned above in the description and also features and feature combinations mentioned below in the detailed description and/or shown in the drawings individually can be used not only in the respectively indicated combination but also in other combinations or in the individual case.

Other features which are considered as characteristic for the invention are set forth in the appended claims.

Although the invention is illustrated and described herein as embodied in a household appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic sectional view of an embodiment of a household appliance according to the invention;

FIG. 2 is a diagrammatic exploded, perspective view of an embodiment of the household appliance according to the invention;

FIG. 3 is a perspective view of a preferred arrangement of a primary induction coil and a first magnetic conductor;

FIGS. 4A to 4D are illustrations showing projections of a first central column and a first sidewall of the first magnetic conductor on an operation surface;

FIG. 5 is a diagrammatic, sectional view of a preferable embodiment of the household appliance according to the invention;

FIGS. 6A to 6D are illustrations showing projections of a second central column and a second sidewall of a second magnetic conductor on the operation surface;

FIG. 7 is a diagrammatic, sectional view of a preferable embodiment of a household appliance according to the invention; and

FIG. 8 is a diagrammatic, sectional view of another preferable embodiment of the household appliance according to the invention.

### DETAILED DESCRIPTION OF THE INVENTION

In the respective embodiments described differently, the same elements are provided with the same reference signs or the same element names. The disclosures contained in the full text of the description can be transferred according to the meaning to the elements provided with the same reference signs or the same element names. In addition, in the respective embodiments, the number, implementation and/or arrangement of the elements are not limited to the examples shown, and other numbers, implementations and/or arrangements can be selected according to actual needs. It is noted that the dimensions of the elements in the figures may be exaggerated to show elements of the present utility model for clarity.

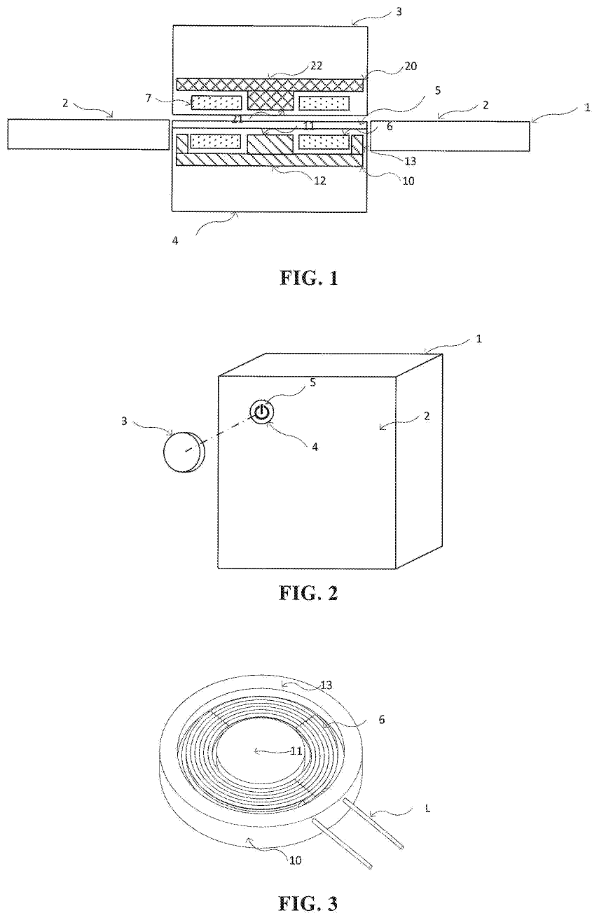

FIG. 1 shows a schematic sectional view of an embodiment of a household appliance according to the present invention. The household appliance contains: an appliance body 1 containing a metal panel 2, and a detachable control device 3. A button 4 is embedded in the metal panel 2, the button has an operation surface 5 made of an non-conductive material, a primary induction coil 6 is integrated on the rear side of the operation surface, and a secondary induction coil 7 is integrated in the detachable control device 3, so that the detachable control device 3, in particular the battery thereof, can be charged by means of the magnetic flux conducted between the primary induction coil 6 and the secondary induction coil 7 when the detachable control device 3 overlies the button 4. It is to be noted that for clarity reasons other mechanical parts, electrical elements and circuit connections of the detachable control device 3 and the buttons 4 are not shown in the figures.

In this exemplary embodiment, it is provided that the primary induction coil 6 is provided with a first magnetic conductor 10 indicated by diagonal shadow, the first magnetic conductor 10 contains a first central column 11 located in the center of the primary induction coil 6, a first flat plate 12 carrying the primary induction coil 6 and a first sidewall 13 at least partially encircling the periphery of the primary induction coil 6. The secondary induction coil 7 is provided with a second magnetic conductor 20 shown by grid shading. The second magnetic conductor 20 at least contains a second central column 21 located in the center of the secondary induction coil 7 and a second flat plate 22 carrying the secondary induction coil 7, by means of the first magnetic conductor 10 and the second magnetic conductor 20, the conducted magnetic flux tightly surrounds the primary induction coil 6 and the secondary induction coil 7. Here, the magnetic flux at the outer periphery of the primary induction coil 6 is guided by the first sidewall 13 and is transmitted or received by the first sidewall 13 at the upper end in FIG. 1. Accordingly, the density and direction of the magnetic flux conducted between the primary induction coil 6 and the secondary induction coil 7 can be controlled by the first magnetic conductor 10 and the second magnetic conductor 20 to enable the magnetic field distribution to be more concentrated, so that the conducted magnetic flux tightly surrounds the primary induction coil 6 and the secondary induction coil 7 and escapes to the metal panel 2 as little as possible, thereby reducing the magnetic flux leakage on the area of the metal panel 2, thus suppressing the heating of the metal panel 2 due to the induced eddy currents, obviously reducing the eddy current loss, and significantly increasing the efficiency of the wireless charging.

As can be seen from FIG. 1, the primary induction coil 6 and the secondary induction coil 7 are expediently aligned with each other, as are the first central columns 11 and the second central column 12 located at their respective centers, thereby efficiently guiding the magnetic flux passing through the centers of the primary induction coil 6 and the secondary induction coil 7. In order to improve the charging efficiency, the primary induction coil 6 and the secondary induction coil 7 overlap each other in the vertical direction and are to be as close to each other as possible in accordance with convention. For this purpose, the first central column 11, the primary induction coil 6 and the first sidewall 13 are flush with one another on the side close to the operation surface 5, while the secondary induction coil 7 and the second central column 21 are flush with one another on the side close to the operation surface 5.

FIG. 2 shows a schematic exploded view of an embodiment of a household appliance according to the present utility model. Here, the household appliance exemplarily contains an appliance body 1 in the shape of a rectangular parallelepiped and a cylindrical detachable control device 3. The appliance body 1 has a metal panel 2 on a side facing a user, and a button 4 is embedded in the metal panel 2. In FIG. 2, the detachable control device 3 indicated by a dot-dash line needs to be aligned with and overly the button 4 when performing wireless charging.

As shown in FIGS. 1 and 2, only the button 4 is introduced into the metal panel 2 of the appliance body 1, thereby maintaining the metal appearance of the appliance body 1 as a whole as much as possible; while the detachable control device 3 is wirelessly charged through the small area where the buttons 4 are located. As a result, on the one hand, industrial design of the household appliance with ultimate simplicity and metallic look is maintained, while on the other hand, the detachable control device can be wirelessly charged, improving convenience of use.

The appliance body 1 as shown in FIG. 2 may be, for example, a refrigerator, a dishwasher, an electric oven, an electric steamer, a microwave oven, an electric rice cooker, a coffee maker, a stove, a washing machine, a clothes dryer, an electric water heater or a stereo, or the like.

Here, it is particularly advantageous that the detachable control device 3 is configured as a rotary knob. Preferably, the rotary knob detects the rotational operation and the pressing operation of the user. The buttons 4 shown in FIGS. 1 and 2 may be, for example, mechanical keys or touch keys. Here, the mechanical key can change its on-off state by exerting an external force on its operation surface 5. And the touch key can change its on-off state based on detection of human body contact and/or approach to the touch key.

The button 4 in FIG. 2 is exemplarily configured as a power button. By means of the power button, the user can turn on or off the power of the appliance body 1. An icon representing a power switch is exemplarily formed on the operation surface 5 of the button 4.

FIG. 3 shows a perspective view of a preferred arrangement of the primary induction coil 6 and the first magnetic conductor 10. Here, the first sidewall 13 completely surrounds the periphery of the primary induction coil 6, i.e. the projection of the first sidewall 13 on the operation surface 5 is in the shape of circular ring. Such an arrangement makes it possible to minimize magnetic leakage to the metal panel 2 and to shield the interior of the appliance body 1 from magnetic fields. As also can be seen from FIG. 3, the primary induction coil 6 can be received in the annular groove formed by the first central column 11, the first flat plate 12 and the first sidewall 13 of the first magnetic conductor 10. In addition to this illustration, FIG. 3 also schematically shows the lead L of the primary induction coil 6. The lead L may be guided outwards through the first sidewall 13, in particular through respective slots or apertures.

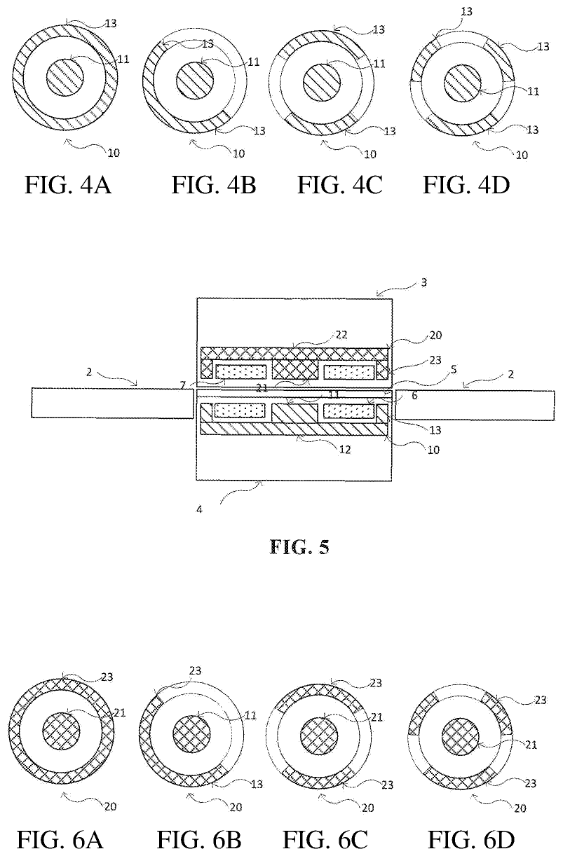

FIGS. 4A to 4D respectively show projections of the first central column and the first sidewall of the first magnetic conductor on the operation surface. FIG. 4A shows the projection of the first magnetic conductor 10 in FIG. 3, as can be clearly seen, the projection of the first sidewall 13 on the operation surface 5 is in the shape of circular ring. FIG. 4B shows that the projection of the first sidewall 13 on the operation face 5 is in the shape of semi-circular ring, in which case the first sidewall 13 will only surround half of the periphery of the primary induction coil 6. FIG. 4C shows that the projection of the first sidewall 13 on the operation surface 5 is in the form of two annular sectors spaced apart from one another, in which case the first sidewall 13 also surrounds only approximately half of the periphery of the primary induction coil 6 in total on the opposite sides of the primary induction coil 6. FIG. 4D shows that the projection of the first sidewall 13 on the operation surface 5 is in the form of three annular sectors spaced apart from one another, which makes it possible to achieve a more uniform distribution of the magnetic flux in the circumferential direction with only a small amount of magnetically conductive material, as compared to the solutions of FIGS. 4B and 4C.

Preferably, the projection area of the first sidewall 13 on the operation surface 5 can substantially correspond to the projection area of the first central column 11 on the operation surface 5.

In particular, the first magnetic conductor 10 and the second magnetic conductor 20 can be made of a material having a high magnetic permeability. Preferably, the first magnetic conductor 10 and/or the second magnetic conductor 20 can be made of ferrite.

FIG. 5 shows a schematic sectional view of a preferable embodiment of a household appliance according to the present utility model. The difference compared to the embodiment shown in FIG. 1 is that in the example shown in FIG. 5, the second magnetic conductor 20 further contains a second sidewall 23 which at least partially encircles the periphery of the secondary induction coil 7. By arranging a second sidewall 23, in particular a second sidewall 23 corresponding to the projection of the first sidewall 13, the magnetic flux can be confined in the magnetic path determined by the first magnetic conductor 10 and the second magnetic conductor 20, thereby optimizing the orientation and distribution of the wireless charging magnetic field again, further reducing eddy current loss and improving the wireless charging efficiency. As shown in FIG. 5, the magnetic flux at the outer peripheries of the primary induction coil 6 and secondary induction coil 7 is more intensively conducted between the upper end of the first sidewall 13 and the lower end of the second sidewall 23, further suppressing the escape of the magnetic flux to the metal panel 2.

FIG. 6A to 6D respectively show projections of the second central column and the second sidewall of the second magnetic conductor on the operation surface. Similarly to the situation shown in FIGS. 4A to 4C, the projection of the second sidewall 23 on the operation surface 5 is in the shape of a circular ring (FIG. 6A), a semi-circular ring (FIG. 6B), or two annular sectors spaced apart from each other (FIG. 6C) or three annular sectors spaced apart from each other (FIG. 6D). Here, the second magnetic conductor 20 shown in FIG. 6A and the secondary induction coil 7 enclosed by it can also be configured in the arrangement shown in FIG. 3.

Preferably, the projection area of the second sidewall 23 on the operation surface 5 can substantially correspond to the projection area of the second central column 21 on the operation surface 5.

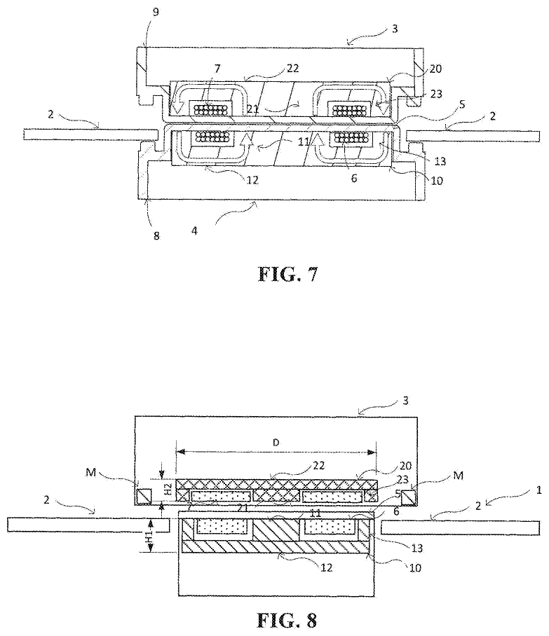

FIG. 7 shows a sectional view of a preferable embodiment of a household appliance according to the present utility model, in which the toroidal magnetic circuit at a certain moment, i.e. in relation to the detachable control device 3 and the button 4, is shown in detail. FIG. 7 shows in particular the primary induction coil 6 and the secondary induction coil 7 in detail, which are respectively formed as coiled double-layers of induction coils on a plane parallel to the operation surface 5, as a result of which the inductance, the quality factor and the resistance can be increased and thus the charging effect can be optimized.

Encircling both the primary induction coil 6 and the secondary induction coil 7, the toroidal magnetic circuit at a certain moment is schematically marked with hollow arrows in the first magnetic conductor 10 and the second magnetic conductor 20. It can be seen that the magnetic flux around the primary induction coil 6 is concentrated in the first central column 11 from the upper end of the first sidewall 13 via the first flat plate 12. The magnetic flux will then be emitted from the upper end of the first central column 11, through the operation face 5 made of electrically non-conductive material and the lower surface of the detachable control device 3 to the lower end of the second central column 21 of the second magnetic conductor. The magnetic flux will then pass around the secondary induction coil 7 via the second flat plate 22 into the second sidewall 23, and will then be emitted from the lower end of the second sidewall 23, again through the lower surface of the detachable control device 3 and the operation face 5 back to the upper end of the first sidewall 13. It can be seen that the magnetic flux is confined to the approximately closed loop magnetic circuit defined by the first magnetic conductor 10 and the second magnetic conductor 20, and leakage flux that escapes onto metal panel 2 hardly occurs, thus suppressing the occurrence of eddy current heating and significantly improving the wireless charging efficiency, as compared to the case where the first magnetic conductor 10 and the second magnetic conductor 20 are not provided.

In particular, the respective portions of the first magnetic conductor 10 and the second magnetic conductor 20 are not divided in FIG. 7. It is thus clear that the first central column 11, the first flat plate 12 and the first sidewall 13 in the first magnetic conductor 10 can be integrally formed, and the second central column 21, the second flat plate 22 and, if necessary, the second sidewall 23 in the second magnetic conductor 20 can also be integrally formed.

In FIG. 7, the projection of the secondary inductive coil 7 on the operation surface 5 overlaps the projection of the primary inductive coil 6 on the operation surface 5, and the projection area of the second sidewall 23 on the operation surface 5 is equal to the projection area of the first sidewall 13 on the operation surface 5.

FIG. 7 also shows the second housing 9 of the detachable control device 3 and the first housing 8 of the button 4. The outer flange of the first housing 8 can rest against the rear side of the metal panel 2, so that the operation surface 5 of the button 4 protrudes from the metal panel 2 in the case of charging the detachable control device 3. It is advantageous to avoid magnetic leakage to the metal panel area by making the button 4 slightly higher than the metal panel 2.

FIG. 8 shows a sectional view of another preferable embodiment of a household appliance according to the present utility model. The thickness H1 of the first magnetic conductor 10 is greater than the thickness H2 of the second magnetic conductor 20 in a vertical direction perpendicular to the operation surface 5. The thickness H1 of the first magnetic conductor 10 may be, for example, between 7 and 15 mm, in particular 10 mm. The thickness H2 of the second magnetic conductor 20 may be, for example, between 2.5 and 5 mm, in particular 3.6 mm. The diameter D of the first magnetic conductor 10 and the second magnetic conductor 20 may be such as between 15 and 28 mm, preferably about 23 mm.

FIG. 8 also shows that the projection of the secondary induction coil 7 on the operation surface 5 slightly exceeds the projection of the primary induction coil 6 on the operation surface 5, so as to avoid the impact on wireless charging caused by dislocation that may occur when the detachable control device is overlaying the button. Besides, the projection area of the second sidewall 23 on the operation surface 5 is larger than the projection area of the first sidewall 13 on the operation surface 5, also actively directing the magnetic flux of the primary induction coil 6 and the secondary induction coil 7.

FIG. 8 further shows, in the detachable control device 3, two magnets M for attaching the detachable control device 3 to the metal panel 2 are provided on the outer side of the secondary induction coil 7 and the second magnetic conductor 20. The second sidewall 23 here can in particular protect the wireless charging magnetic field from the interference by the magnets M.

The present invention is not limited to the embodiments shown, but includes or extends to all technical equivalents falling within the effective range of the appended claims. The positional descriptions selected in the description such as “top”, “bottom”, “left”, “right”, etc., refer to the direct description and the illustrated figures and can be transferred to new positions in accordance with the meaning when the position changes.

The features disclosed in this application document can be not only individually but also in any combination, which is important for the implementation of the embodiments in terms of different design solutions and can be realized.

Although the present utility model has been described in terms of preferred embodiments, it is not intended to limit the present utility model thereto. Those skilled in the art can make variations and modifications to the present utility model by utilizing the above-described methods and technical contents without departing from the spirit and scope of the present utility model. Accordingly, any contents that do not depart from the technical solution of the present utility model, and all such simple modifications, equivalents and alterations made to the aforesaid embodiments according to the technical spirit of the present utility model, are considered as being within the protection scope of the technical solution of the present utility model.

1. A household appliance, comprising:
an appliance body having a metal panel;
a detachable control device;
a button being embedded in said metal panel, said button having an operation surface made of an non-conductive material and a primary induction coil disposed on a rear side of said operation surface, said button having a first magnetic conductor, said first magnetic conductor having a first central column disposed in a center of said primary induction coil, a first flat plate carrying said primary induction coil and a first sidewall at least partially encircling a periphery of said primary induction coil; and
a secondary induction coil disposed in said detachable control device, so that said detachable control device being charged by means of a magnetic flux conducted between said primary induction coil and said secondary induction coil when said detachable control device overlies said button, said detachable control device having a second magnetic conductor, said second magnetic conductor having a second central column disposed in a center of said secondary induction coil and a second flat plate carrying said secondary induction coil, and by means of said first magnetic conductor and said second magnetic conductor, a conducted magnetic flux tightly surrounds said primary induction coil and said secondary induction coil.

2. The household appliance according to claim 1, wherein a projection of said first sidewall on said operation surface is in a shape of a circular ring, a semi-circular ring, or at least two annular sectors spaced apart from each other.

3. The household appliance according to claim 2, wherein a projection area of said first sidewall on said operation surface substantially corresponds to a projection area of said first central column on said operation surface.

4. The household appliance according to claim 1, wherein said second magnetic conductor further has a second sidewall which at least partially encircles a periphery of said secondary induction coil.

5. The household appliance according to claim 4, wherein a projection of said second sidewall on said operation surface is in a shape of a circular ring, a semi-circular ring, or at least two annular sectors spaced apart from each other.

6. The household appliance according to claim 4, wherein a projection area of said second sidewall on said operation surface substantially corresponds to a projection area of said second central column on said operation surface.

7. The household appliance according to claim 1, wherein said first magnetic conductor and said second magnetic conductor are made of a material having a high magnetic permeability.

8. The household appliance according to claim 7, wherein said first magnetic conductor and/or said second magnetic conductor are made of ferrite.

9. The household appliance according to claim 1, wherein said first magnetic conductor has a thickness greater than a thickness of said second magnetic conductor in a vertical direction perpendicular to said operation surface.

10. The household appliance according to claim 9, wherein:
the thickness of said first magnetic conductor is between 7 and 15 mm; and/or
the thickness of said second magnetic conductor is between 2.5 and 5 mm; and/or
diameters of said first magnetic conductor and said second magnetic conductor lie between 15 and 28 mm.

11. The household appliance according to claim 1, wherein said primary induction coil and said secondary induction coil are respectively formed as one or more layers of induction coils wound on a plane parallel to said operation surface.

12. The household appliance according to claim 1, wherein a projection of said secondary induction coil on said operation surface overlaps or exceeds a projection of said primary induction coil on said operation surface.

13. The household appliance according to claim 4, wherein the projection area of said second sidewall on said operation surface is equal to or greater than the projection area of said first sidewall on said operation surface.

14. The household appliance according to claim 1, further comprising at least one magnet disposed in said detachable control device, said at least one magnet attaching said detachable control device to said metal panel is disposed on an outer side of said secondary induction coil and said second magnetic conductor.

15. The household appliance according to claim 1, wherein said operation surface of said button protrudes from said metal panel in a case of charging of said detachable control device.

16. The household appliance according to claim 1, wherein said appliance body is a body of refrigerator, a dishwasher, an electric oven, an electric steamer, a microwave oven, an electric rice cooker, a coffee maker, a stove, a washing machine, a clothes dryer, an electric water heater or a stereo.
